(19) United States
(12) Patent Application Publication
(10) Pub. No.: US 2026/0367925 A1
(43) Pub. Date: Nov. 19, 2026

(54) COMPONENT LOADING METHOD, USER DEVICE, AND COMPUTER-READABLE STORAGE MEDIUM

(71) Applicant: BYTEDANCE TECHNOLOGY LTD., Grand Cayman (KY)

(72) Inventors: Haoyu WANG, Beijing (CN); Songkai JIA, Beijing (CN); Jing CHEN, Beijing (CN)

(21) Appl. No.: 19/679,580

(22) Filed: May 15, 2026

(30) Foreign Application Priority Data
May 16, 2025 (CN) 202510641728.0

(51) Int. Cl. G06F 9/4401

(52) U.S. Cl. CPC G06F 9/4411

(57) ABSTRACT

The present disclosure relates to the field of computer technology, and in particular, to a component loading method, a user device, and a computer-readable storage medium. The component loading method includes: receiving first configuration information, the first configuration information including a loading sequence of functions to be loaded; determining second configuration information according to a correspondence between functions and components and the first configuration information, the second configuration information including a loading sequence of components corresponding to the functions; and loading the components according to the second configuration information.

### CROSS-REFERENCE TO RELATED APPLICATIONS

This application claims priority to Chinese Patent Application No. 202510641728.0, entitled “Component loading methods, user device, and computer-readable storage media”, and filed on May 16, 2025. The entire disclosure of the prior application is hereby incorporated by reference in its entirety.

### TECHNICAL FIELD

The present disclosure relates to the field of computer technology, and in particular, to a component loading method, a user device, a computer-readable storage medium, and a computer program product.

### BACKGROUND

With the development of science and technology, users’ requirements for loading smoothness in a process of using devices such as mobile phones and computers are getting higher and higher, especially in a video playback scenario such as live streaming, the loading speed of video content has a great impact on users’ experience. In order to improve the loading speed, different loading strategies may be required to perform loading in different situations.

However, in the related art, during a process of loading components, a strategy of component loading is usually fixed in code logic, and each time the component loading sequence needs to be adjusted, the code logic needs to be modified and a version of the code needs to be updated, resulting in poor flexibility of component loading.

### SUMMARY

In view of this, embodiments of the present disclosure provide a component loading method, a user device, a computer-readable storage medium, and a computer program product, which may allow the user device to parse received function loading configuration information, through a correspondence between functions and components, to obtain specific component loading configuration information, and perform loading according to the component loading configuration information.

When different function loading configuration information is received, the corresponding component loading configuration information may be determined by parsing the function loading configuration information, so as to directly adjust the loading sequence of the components, without modifying the code logic or updating the version of the code, thus improving the flexibility of component loading.

According to some embodiments of the present disclosure, a component loading method is provided, comprising: receiving first configuration information, the first configuration information comprising a loading sequence of functions to be loaded; determining second configuration information according to a correspondence between functions and components and the first configuration information, wherein the second configuration information comprises a loading sequence of components corresponding to the functions; and loading the components according to the second configuration information.

According to some other embodiments of the present disclosure, a user device is provided, comprising: a receiving module configured to receive first configuration information, the first configuration information comprising a loading sequence of functions to be loaded; a determination module configured to determine second configuration information according to a correspondence between functions and components and the first configuration information, wherein the second configuration information comprises a loading sequence of components corresponding to the functions; and a loading module configured to load the components according to the second configuration information.

According to still some embodiments of the present disclosure, a user device is provided, comprising: at least one memory; and at least one processor coupled to the memory, the at least one processor configured to, based on instructions stored in the memory, execute the component loading method of any one of the embodiments described in the present disclosure.

According to yet some embodiments of the present disclosure, a computer-readable storage medium is provided, having a computer program stored thereon, where the program, when executed by a processor, executes the component loading method of any one of the embodiments described in the present disclosure.

According to yet some embodiments of the present disclosure, a computer program product is provided, which, when running on a computer, causes the computer to implement the component loading method of any one of the embodiments described in the present disclosure.

Other features, aspects, and advantages of the present disclosure will become apparent through the following detailed description of the exemplary embodiments of the present disclosure with reference to the drawings.

### BRIEF DESCRIPTION OF THE DRAWINGS

Embodiments of the present disclosure are described hereinafter with reference to the drawings. It is to be understood that the drawings in the following description relate only to some embodiments of the present disclosure, but not to limit the present disclosure. In the drawings:

FIG. 1 shows a flowchart of a component loading method according to some embodiments of the present disclosure;

FIG. 2 is a flowchart of determining second configuration information according to some embodiments of the present disclosure;

FIG. 3 is a flowchart of component loading according to some embodiments of the present disclosure;

FIG. 4 is a flowchart of a component loading method according to some other embodiments of the present disclosure;

FIG. 5 is a schematic diagram of component loading according to some embodiments of the present disclosure;

FIG. 6 is a schematic diagram of loading a live streaming component according to some embodiments of the present disclosure;

FIG. 7 shows a block diagram of a user device according to some embodiments of the present disclosure;

FIG. 8 shows a block diagram of a user device according to some other embodiments of the present disclosure;

FIG. 9 shows a block diagram of an electronic device according to some embodiments of the present disclosure.

It is to be noted that, for ease of description, the dimensions of various parts shown in the drawings are not necessarily drawn to scale. Throughout the drawings, the same or similar reference numerals refer to the same or similar parts. Therefore, once an item is defined in one drawing, it may not be discussed further in subsequent drawings.

### DETAILED DESCRIPTION

The technical solutions in the embodiments of the present disclosure are described hereinafter clearly and completely with reference to the drawings in the embodiments of the present disclosure. It is to be understood that the present disclosure may be implemented in various forms and should not be construed as limited to the embodiments set forth herein.

It is to be understood that the various steps recited in the method implementations of the present disclosure may be performed in a different order and/or in parallel. In addition, the method implementations may comprise additional steps and/or omit performing the illustrated steps. The scope of the present disclosure is not limited in this respect. Unless otherwise specifically stated, the relative arrangements and values of components and steps set forth in these embodiments are to be construed as merely exemplary and do not limit the scope of the present disclosure.

The term "include/comprise" and its variants used in the present disclosure are open-ended terms that mean " include/comprise at least the following elements/features, but do not exclude other elements/features", that is, " include/comprise but not limited to". The term "based on" means "based at least in part on".

It is to be noted that concepts such as "first" and "second" mentioned in the present disclosure are merely used to distinguish between different apparatuses, modules, or units, and are not used to limit the order of functions performed by these apparatuses, modules, or units or interdependence therebetween. Unless otherwise specified, concepts such as "first" and "second" are not intended to imply that the objects so described must be in a given order temporally, spatially, in ranking, or in any other way.

It is to be noted that modifications of "one" and "a plurality of" mentioned in the present disclosure are illustrative rather than restrictive, and those skilled in the art should understand that "one" or "a plurality of" should be understood as "one or more" unless otherwise clearly indicated in the context.

The names of messages or information exchanged between a plurality of apparatuses in the implementations of the present disclosure are used for illustrative purposes only, and are not used to limit the scope of these messages or information.

Embodiments of the present disclosure are described in detail hereinafter with reference to the drawings, but the present disclosure is not limited to these specific embodiments. The following specific embodiments may be combined with each other, and the same or similar concepts or processes may not be described in detail in some embodiments. In addition, in one or more embodiments, specific features, structures, or characteristics may be combined in any suitable manner as will be clear to those of ordinary skill in the art from this disclosure.

In the related art, during a process of loading components, a strategy of component loading is usually fixed in code logic, and each time a different loading strategy needs to be used to perform loading, the code logic needs to be modified and a version of the code needs to be updated, resulting in poor flexibility of component loading.

In order to improve the flexibility of component loading, embodiments of the present disclosure provide a new component loading method, which may allow a user device to parse received function loading configuration information, through a correspondence between functions and components, to obtain specific component loading configuration information, and perform loading according to the component loading configuration information.

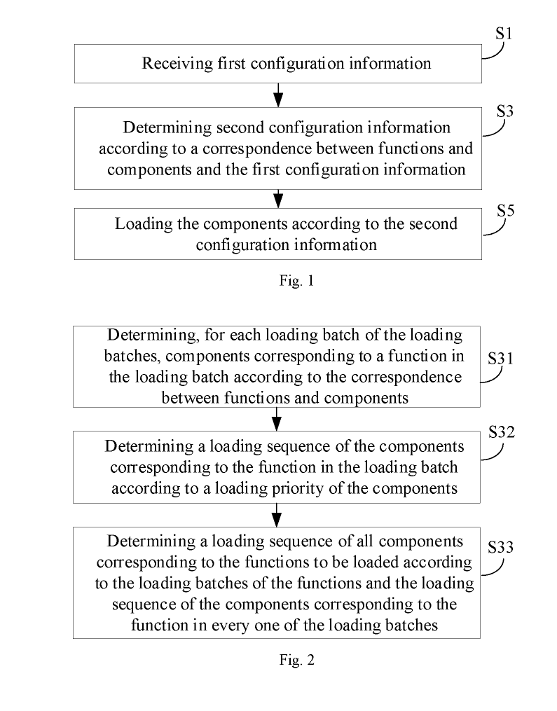

FIG. 1 shows a flowchart of a component loading method according to some embodiments of the present disclosure.

As shown in FIG. 1, the component loading method comprises: step S1, receiving first configuration information, the first configuration information comprising a loading sequence of functions to be loaded; step S3, determining second configuration information according to a correspondence between functions and components and the first configuration information, wherein the second configuration information comprising a loading sequence of components corresponding to the functions; and step S5, loading the components according to the second configuration information.

The component loading method may be performed by a user device such as a mobile phone or a computer, and can be used for component loading in a video playback scenario such as live streaming.

The first configuration information may be generated by a cloud end or a server end and sent to the user device, for example. The first configuration information may comprise a loading sequence of functions to be loaded, such as a loading sequence of the functions and/or a loading batch of the functions. The first configuration information may comprise only relatively rough information related to the function, and does not need to comprise detailed loading information related to the components.

The user device may obtain the second configuration information by parsing the first configuration information according to the correspondence between functions and components, for example. The second configuration information may comprise a loading sequence of components corresponding to the functions in the first configuration information, such as a loading sequence of the components and/or a loading batch of the components. After receiving the relatively rough first configuration information, the user device may parse the first configuration information according to the correspondence to obtain detailed component loading configuration information.

The correspondence between functions and components may be stored in code logic of the user device, so that the parsed second configuration information is in a form of code logic, which may be directly used by the user device to load the components. For example, the correspondence between functions and components may be stored in the code logic in a form of a function-component mapping table.

The component loading method may allow the user device to parse the received function loading configuration information through the correspondence between functions and components to obtain specific component loading configuration information, and perform loading according to the component loading configuration information.

By establishing the above basic framework that may support dynamic component loading configuration, for example, in response to testing being required or a change in the application scenario of the user device being detected, the cloud end may generate different first configuration information, and the user device, when receiving the different first configuration information, may obtain the corresponding second configuration information by parsing, so as to adjust the loading sequence of the components, without modifying the code logic or updating the version of the code, thus improving the flexibility of component loading.

The component loading method according to some embodiments of the present disclosure is described above with reference to FIG. 1. Next, with reference to FIG. 2, how to specifically determine the second configuration information in response to the loading sequence of the function comprising the loading batches of the functions is described.

FIG. 2 is a flowchart of determining second configuration information according to some embodiments of the present disclosure. As shown in FIG. 2, step S3, determining the second configuration information according to the correspondence between functions and components and the first configuration information may comprise: step S31, determining, for each loading batch of the loading batches, components corresponding to a function in the loading batch according to the correspondence between functions and components; step S32, determining a loading sequence of the components corresponding to the function in the loading batch according to a loading priority of the components; and step S33, determining a loading sequence of all components corresponding to the functions to be loaded according to the loading batches of the functions and the loading sequence of the components corresponding to the function in every one of the loading batches.

The first configuration information in the component loading method defines the loading sequence of the functions by dividing the loading batches of the functions. For example, in response to the functions to be loaded comprising five functions A to E, the functions may be divided into three loading batches, and the first configuration information may indicate that the function A belongs to a first loading batch, the functions B and C belong to a second loading batch, and the functions D and E belong to a third loading batch. The loading batches are performed sequentially in the loading process, that is, the function A is loaded first, then the functions B and C are loaded, and finally the functions D and E are loaded.

In some embodiments, the first configuration information is dynamically changed and determined according to at least one of a application scenario or a testing requirement.

The cloud end or the server end, for example, may generate different first configuration information in different scenarios and send the different first configuration information to the user device.

Taking component loading when watching live streaming as an example, different application scenarios refer to different ways for a user to enter a live streaming room, for example, a user may enter the live streaming room from a preview user interface(UI) in a video stream, or may enter the live streaming room by triggering a live streaming control in a display UI. In the different scenarios described above, by sending different first configuration information for the user device to parse, a corresponding loading strategy may be flexibly applied, thereby improving the loading smoothness and improving the user experience.

In addition, in order to explore the impact of different loading strategies on the loading speed, user experience, etc., the cloud end usually needs to test a plurality of different loading strategies. In the component loading method of the present disclosure, the cloud end may generate different first configuration information and send the different first configuration information to the user device to instruct the user device to load the components in different orders, thereby performing testing. In the testing process, there is no need to modify the code logic or update the version of the code, thus reducing the verification cost of the loading strategy.

In step S31, after receiving the first configuration information, the user device may determine components corresponding to the function in each loading batch of the loading batches, respectively.

Continuing to refer to the example in which the functions to be loaded comprise five functions A to E, each loading batch may be considered separately. For example, for the first loading batch comprising the function A, it may be determined that the component corresponding to the function in the first loading batch is the component a1 for implementing the function A. For another example, for the second loading batch comprising the functions B and C, it may be determined that the components corresponding to the functions in the second loading batch are the component b1 for implementing the function B and the components c1 and c2 for implementing the function C.

Through the above method, in addition to determining the components required to implement the functions, the correspondence between the components and the loading batches may also be determined, for example, the component a1 belongs to the first loading batch of the components, the components b1, c1, and c2 belong to the second loading batch of the components, and the components d1, e1, and e2 belong to the third loading batch of the components. Through the correspondence, it may be ensured that the loading batches of the components in the parsed second configuration information corresponds to the loading batches of the functions in the first configuration information.

In step S32, after the components corresponding to the function in each loading batch are determined, the loading sequence of the components in the loading batch may be determined according to the loading priority of the components stored in the user device.

After it is determined that the components b1, c1, and c2 belong to the second loading batch, the loading sequence of the components in the second loading batch may be determined according to the loading priority of these components. For example, in response to the component c2 having the highest priority and the component b1 having the lowest priority, it may be determined that the loading sequence of the components in the second loading batch is: the component c2, the component c1, and the component b1. Similarly, it may be determined that the loading sequence of the components in the third loading batch is: the component e1, the component d1, and the component e2.

The loading priority of the components may be stored in the user device in a form of component loading sequence table, for example. After the components corresponding to the function in each batch are determined, the loading sequence of these components in the loading batch may be determined according to the loading sequence table.

In step S33, the loading sequence of all the components may be determined according to the loading batch of the functions and the loading sequence of the components corresponding to the function in each loading batch.

After the loading sequence of the components in each loading batch of the loading batches is determined, the loading sequences of the components in different loading batches may be combined to determine the loading sequence of all the components for implementing the functions to be loaded, and the loading sequence will be comprised in the second configuration information and used by the user device for subsequent component loading.

In the above example, the loading sequences of the components in the three loading batches may be combined, and the loading sequence of all the components for implementing the functions A to E may be determined as, for example: the component a1 in the first loading batch, the component c2, the component c1, and the component b1 in the second loading batch, and the component e1, the component d1, and the component e2 in the third loading batch.

In the above process of determining the loading sequence of all the components, the loading batch may be set to have a higher priority than the priority of the components. Even in a case where the component c2 has a higher priority than the component a1 in the component loading sequence table, the component a1 in the first loading batch is still loaded first, and then the component c2 in the second loading batch is loaded.

In some embodiments, the second configuration information is in a one-to-one correspondence with the first configuration information. In other words, each piece of first configuration information corresponds to one piece of second configuration information, and the user device will parse out different pieces of second configuration information after receiving different pieces of first configuration information. For example, in a case where the loading batch of the functions in the first configuration information changes, the loading sequence of the components in the second configuration information also changes accordingly, thereby meeting the scenario or testing requirements.

How to determine the loading sequence of the components according to the loading batches of the functions is described above with reference to FIG. 2. With the above configuration, the cloud end or the server end only needs to generate and send a rough function loading configuration comprising only the loading batches, and the user device, after receiving the function loading configuration, may determine a detailed component loading configuration by parsing the correspondence between the functions and the components and combining the priority of the components. When different loading configurations are received, a new component loading configuration may be used to load the components without modifying the code logic or updating the version of the code, thus reducing the time cost and improving the flexibility of component loading.

In some embodiments, in addition to the loading batches of the functions, the first configuration information may further comprise a delay interval between the loading batches of the functions to be loaded, and the delay interval may be understood as a time interval between the start of different loading batches. Correspondingly, the second configuration information obtained by parsing the first configuration information may further comprise a loading delay of the components corresponding to the functions to be loaded, and the loading delay may be understood as a time required for each component to be loaded.

In the above embodiments, step S3, determining the second configuration information according to the correspondence between functions and components and the first configuration information further comprises: determining, for each loading batch of the loading batches, a loading delay of components corresponding to the function in the loading batch according to a delay interval between the loading batch and a next loading batch.

As described above, for each loading batch, the delay interval between the loading batch and the next loading batch may refer to a time interval between the start of the loading batch and the start of the next loading batch. In other words, after a certain time since the start of one loading batch, the next loading batch will start to be loaded. Therefore, in order to avoid overload or blockage caused by simultaneous loading of a plurality of loading batches, it is necessary to complete the loading of the loading batch within the delay interval.

After receiving the delay interval, the user device may adjust the loading delay of the components in the loading batch, so that the sum of the loading delays of the components in the loading batch is less than or equal to the delay interval. In other words, the user device may adjust the time required for each component to be loaded, so that the sum of the time required for all the components in the loading batch to be loaded is less than or equal to the delay interval, that is, the loading of the loading batch may be completed before the next loading batch starts to be loaded.

For example, the first configuration information sent by the cloud end may comprise that the delay interval between a first loading batch and a second loading batch is 30 seconds. After receiving the first configuration information, the user device may first determine the components corresponding to the function in the first loading batch. For example, the first loading batch comprises the function A, and the corresponding components are the components a1, a2, and a3. According to the delay interval in the first configuration information, the user device may determine that the total loading time of the components a1, a2, and a3 is 30 seconds, and then may specifically determine that the loading delay of the component a1 is 5 seconds, the loading delay of the component a2 is 15 seconds, and the loading delay of the component a3 is 10 seconds.

By comprising the delay interval in the first configuration information, the cloud end may be allowed to control the loading delay of each component loaded by the user device, thereby adjusting the speed of the loading process, and compared with the use of a fixed loading delay, the flexibility of the loading process is improved in the above solution of the present disclosure.

Further, determining the loading delay of the components corresponding to the function in the loading batch according to the delay interval between the loading batch and the next loading batch may comprise: determining the loading delay according to the delay interval and a state of the user device, the state of the user device comprising at least one of a resource usage state or a network state.

In addition to the adjustment of the loading delay of the components by the cloud end through sending the delay interval, the user device may also adjust the loading delay according to its own state in the process of determining the loading delay. In the above example, the user device, when determining that the total loading time of the components a1, a2, and a3 is 30 seconds, may specifically determine the loading delay of each component according to its own resource usage. For example, when there is less memory resources, the loading delay of the components loaded using the memory may be increased and the loading delay of other components may be reduced. For another example, when there are more processor resources, the loading delay of the components loaded using the processor may be reduced and the loading delay of other components may be increased.

On the basis of the aforementioned basic framework, the expansion is carried out through the above configuration, which implements the autonomous adjustment of the loading delay by the user device, and the user device may dynamically schedule the loading delay of the components according to the current performance state, thereby further improving the flexibility of the loading process.

It may be seen that the basic framework proposed in the present disclosure has a high expandability, and through different parsing settings, the user device may achieve different purposes without changing the code logic.

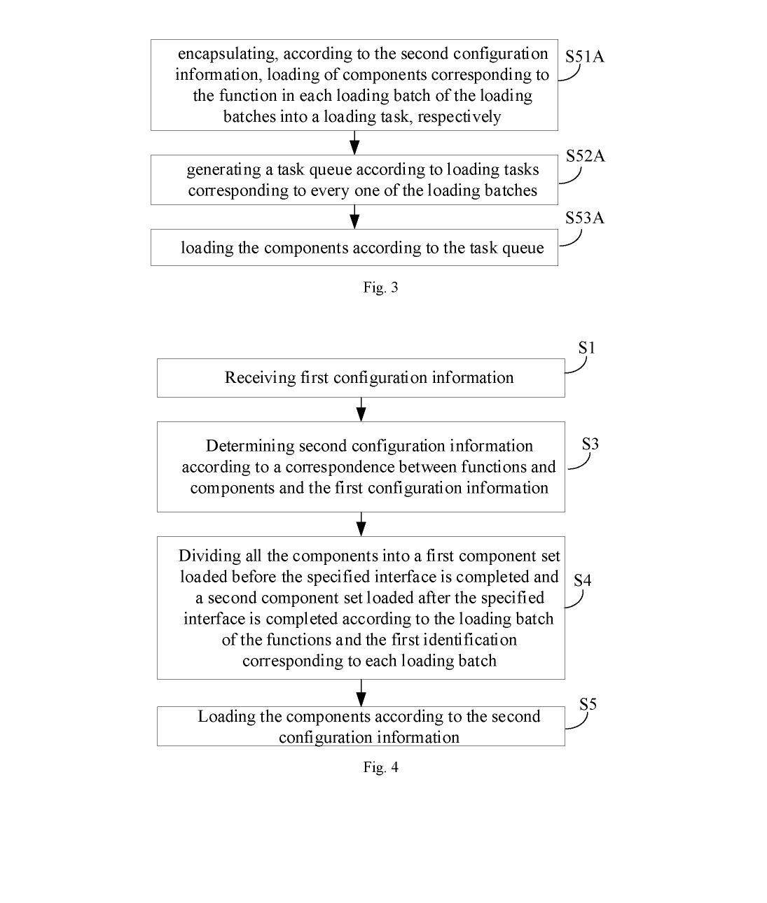

How to determine the loading delay of the components according to the delay interval in the first configuration information in response to the first configuration information comprising the loading batches is described above. Next, with reference to FIG. 3, how to perform component loading based on the second configuration information after the second configuration information is determined is described.

FIG. 3 is a flowchart of performing component loading according to some embodiments of the present disclosure. As shown in FIG. 3, step S5, loading the components according to the second configuration information may comprise: step S51A, encapsulating, according to the second configuration information, loading of the components corresponding to the function in each loading batch of the loading batches into a loading task, respectively; step S52A, generating a task queue according to loading tasks corresponding to every one of the loading batches; and step S53A, loading the components according to the task queue.

In step S51A, the components in each loading batch are encapsulated into the loading task according to the loading sequence and the loading delay indicated in the second configuration information, respectively.

Each loading batch may correspond to a separate loading task, and when the loading task is running, the components may be loaded according to the specified loading sequence and loading delay. The user device may allocate processor resources and memory resources to load the components according to the determined loading delay.

For example, for a certain component, when the determined loading delay is 5 seconds, 30% of the processor resources need to be used to complete the loading within 5 seconds, and when the determined loading delay is 3 seconds, 50% of the processor resources need to be used to complete the loading within 3 seconds.

In step S52A, the loading tasks may be arranged in the order of the loading batch to generate the task queue.

In addition, in response to the first configuration information comprising the delay interval, in order to ensure that the loading process meets the requirements of the first configuration information, in a process of generating the task queue, it may be set that an interval between start times of the loading tasks in the task queue corresponds to the delay interval between the loading batches.

In step S53A, the component loading tasks may be sequentially executed according to the task queue.

In the loading process of the task queue, based on the separate settings of the loading tasks, other operations may be inserted between different loading tasks. For example, in response to the loading task corresponding to the first loading batch being completed ahead of schedule, other operations may be performed until after a preset interval, and then the loading task corresponding to the second loading batch is started to be performed.

Compared with the related art in which all the components are loaded at once, the above steps of the present disclosure, through the separate settings of the loading tasks, improve the utilization and flexibility of resources, and improve the component loading performance.

In addition to the delay interval between the different loading batches, the first configuration information may further comprise a first identification corresponding to each loading batch of the loading batches, the first identification indicating whether the loading batch supports loading before a specified interface is completed. Next, with reference to FIG. 4, how to load the components based on the first identification is described.

FIG. 4 is a flowchart of a component loading method according to some other embodiments of the present disclosure. As shown in FIG. 4, on the basis of FIG. 1, the component loading method further comprises: step S4, dividing all the components into a first component set loaded before the specified interface is completed and a second component set loaded after the specified interface is completed according to the loading batches of the functions and the first identification corresponding to each loading batch.

The loading of the user device is usually not performed separately, but together with other processes. For example, in the loading process, a part of components may be loaded only by calling parameters after other interfaces are completed. Therefore, the first configuration information may additionally carry a corresponding identification to indicate whether each loading batch supports loading before the specified interface is completed, so as to distinguish the functions during subsequent loading.

Based on the identification, it may be sequentially confirmed, starting from the first loading batch, whether the loading before the specified interface is supported, until a loading batch does not support the loading before the specified interface. At this time, the components corresponding to the loading batches before the loading batch does not support the loading before the specified interface may be determined as the first component set, and the components corresponding to the loading batch does not support the loading before the specified interface and the loading batches after may be determined as the second component set.

Taking the component loading for watching live streaming as an example, the specified interface is, for example, a room entry interface of a live streaming room, components such as an interface layout of the live streaming room may be loaded before the room entry interface callback, while components such as room data and live audio and video streams may only be loaded after the room entry interface callback.

The first loading configuration may comprise, for example, five loading batches, where the first identifications corresponding to a first loading batch, a second loading batch, and a fourth loading batch indicate that these loading batches support loading before the room entry interface callback, while the first identifications corresponding to a third loading batch and a fifth loading batch indicate that these loading batches do not support loading before the room entry interface callback.

In the above case, the determination may be started from the first loading batch until the third loading batch does not support the loading before the room entry interface callback. Although the fourth loading batch supports the loading before the room entry interface callback, the fourth loading batch needs to be loaded after the third loading batch, and the third loading batch does not support the loading before the room entry interface callback. Therefore, the components corresponding to the first loading batch and the second loading batch may be determined as the first component set loaded before the room entry interface callback, and the components corresponding to the third loading batch to the fifth loading batch may be determined as the second component set loaded after the room entry interface callback.

Compared with the related art in which fixed loading batches are set before and after the specified interface is completed, in the above embodiments of the present disclosure, the number of loading batches before and after the specified interface is completed may be flexibly set, and whether each component is loaded before the specified interface is completed is distinguished, so as to facilitate the subsequent loading of these components, and improve the flexibility of the loading process.

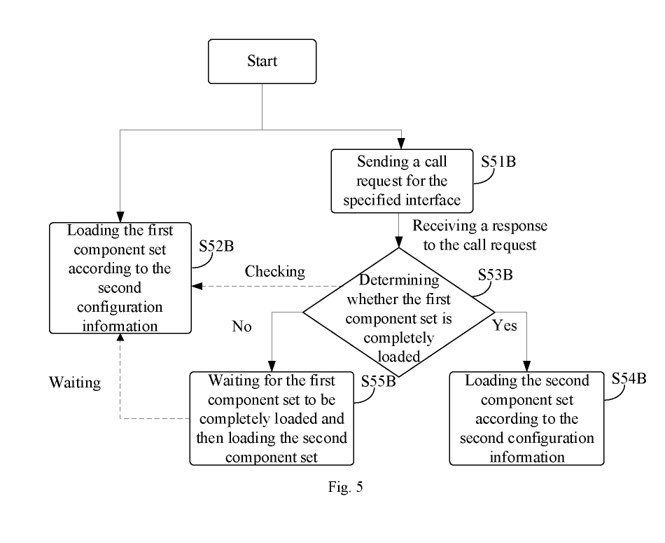

FIG. 5 is a schematic diagram of performing component loading according to some embodiments of the present disclosure. As shown in FIG. 5, after the first component set and the second component set are determined, loading the components according to the second configuration information may comprise: step S51B, sending a call request for the specified interface; step S52B, loading the first component set according to the second configuration information; step S53B, determining whether the first component set is completely loaded in response to receiving a response to the call request; step S54B, loading the second component set according to the second configuration information in response to the first component set being completely loaded; and step S55B, waiting for the first component set to be completely loaded and then loading the second component set in response to the first component set not being completely loaded.

In step S51B, for subsequent use, the call request for the specified interface may be sent, so as to load the corresponding components after receiving a reply.

In step S52B, since the first component set may be loaded before the specified interface is completed, the first component set may be directly loaded according to the second configuration information. After the first component set is completely loaded, if the response to the call request has not been received, the user device may be placed in a waiting state or other operations may be asynchronously performed.

As shown in FIG. 5, step S51B and step 52B may be performed asynchronously. In other words, there is no dependency between the loading of the first component set and the sending of the call request for the specified interface, and the first component set may be loaded in advance without waiting for the specified interface to be completed, thereby improving the loading efficiency, reducing the resource consumption for loading after the specified interface is completed, and making the loading process more balanced.

In step S53B, after receiving the response to the call request, that is, after the specified interface is completed, it may be determined whether the first component set is completely loaded.

in response to the first component set being completely loaded, step S54B is executed, loading the second component set according to the second configuration information.

in response to the first component set not being completely loaded, step S55B is executed to wait for the first configuration information to be completely loaded before loading the second component set.

The above process sets the component loading before the specified interface is completed and the sending of the call request for the specified interface as two asynchronously executed branches, so that the loading of the first component set does not need to wait for the feedback from the specified interface, and the smoothness and flexibility of loading are improved.

How to load the components in the case where the first configuration information further comprises the first identification indicating whether each loading batch supports loading before the specified interface is completed is described above with reference to FIGS. 4 and 5.

In addition to the first identification, the first configuration information may further comprise a second identification corresponding to each loading batch of the loading batches, and the second identification indicates whether the functions in the loading batch are displayed concurrently. Next, how to determine the loading sequence of the components corresponding to the function in the loading batch according to the second identification and the loading priority of the components in step S32 of FIG. 3 is described.

Taking the component loading when watching live streaming as an example, for example, the first loading batch comprises a plurality of functions to be loaded, such as displaying an avatar of a streamer and displaying a live streaming title. The functions may be instructed, through the second identification corresponding to the first loading batch, to be displayed concurrently, thereby avoiding the decline of user experience caused by the functions with high correlation not being displayed concurrently.

In the above embodiments, the second identification may further control the loading process by indicating whether the functions in the loading batch are displayed concurrently. On the basis of the second identification, determining the loading sequence of the components corresponding to the function in the loading batch according to the loading priority of the components comprises: determining, for each loading batch of the loading batches, whether the loading sequence of the components corresponding to the function in the loading batch is loading in parallel according to the second identification corresponding to the loading batch; and determining the loading sequence of the components corresponding to the function in the loading batch according to the loading priority of the components in response to the loading sequence of the components corresponding to the function in the loading batch not being loading in parallel.

In other words, for each loading batch, when determining the loading sequence of the components, it may first be determined, through the second identification, whether the components in the loading batch need to be loaded concurrently. In the case where the components do not need to be loaded concurrently, the loading sequence of the components is then determined according to the loading priority of the components as described above.

For example, in response to the user device having sufficient resources, in order to avoid waiting caused by loading the components sequentially, the components in the loading batch may be loaded in parallel and displayed on a screen at the same time, thereby improving the loading speed and improving the user experience. For another example, in response to the components in the loading batch having a high requirement for real-time performance, in order to display these components concurrently, the components in the loading batch may be loaded in parallel.

With the above configuration, it may be ensured that the components that need to be displayed on the screen concurrently during the loading process may be loaded concurrently, thereby improving the user experience.

The component loading method proposed by the present disclosure is described above with reference to FIGS. 1-5. Next, with reference to FIG. 6, a component loading method in a live streaming scenario is described.

FIG. 6 is a schematic diagram of loading a live streaming component according to some embodiments of the present disclosure. As shown in FIG. 6, the loading method of loading the live streaming component may comprise steps 601 to 624.

In steps 601 to 605, in response to the user device starting an application, the parsing of component loading configuration, that is, the second configuration information, may be started.

Specifically, in step 601, user device can receive the function loading configuration, that is, the first configuration information, from the cloud end. As described above, the first configuration information may be generated by the cloud end according to at least one of the application scenario or the testing requirement. Step 601 corresponds to step S1 in FIG. 1.

In step 602, the function loading configuration is parsed according to a function mapping table. The function mapping table is the correspondence between functions and components, and may be stored locally in the user device, so that the user device may parse the function loading configuration.

In step 603, it is determined whether the parsing is successful.

In the case where the parsing is successful, step 604 is directly executed to generate a component loading configuration that is globally unique to the function loading configuration, and the component loading configuration may be used for live streaming component loading when entering each live streaming room. Steps 602 and 604 correspond to step S3 in FIG. 1.

In the case where the parsing fails, step 605 is executed to load the backup configuration stored locally in the user device, and enter step 604, generating the component loading configuration through the backup configuration.

It may be seen from FIG. 6 that the process of parsing the component loading configuration and the process of performing component loading may be performed asynchronously. In other words, even if the user does not want to enter a live streaming room, the component loading configuration may be parsed after the application is started, without waiting for the user to issue an instruction to enter the live streaming room before parsing the component loading configuration, thereby shortening the component loading time.

In steps 606 to 624, the live streaming components may be loaded, corresponding to step S5 in FIG. 1.

In step 606, in the case where the user issues the instruction to enter the live streaming room, as described above, the process may be divided into two branches, namely, steps 607 to 613 and steps 614 to 624, according to whether the components are loaded before the room entry interface callback of the live streaming room. As shown in FIG. 6, these two branches may also be performed asynchronously.

In step 607, since the process of parsing the component loading configuration and the process of performing component loading are performed asynchronously, when performing component loading, it is first determined whether the loading configuration is parsed completely. In the case where the loading configuration is not parsed completely, the process waits for steps 601 to 605 to be completed before performing subsequent loading.

In the case where the loading configuration is completely parsed, step 608 is executed, where it is determined, according to the relevant identification in the configuration information, whether the components need to be loaded before the room entry interface callback.

In the case where the components do not need to be loaded, step 609 is executed to place the user device in a waiting state, waiting for the room entry interface callback. After the user device is placed in the waiting state, other operations besides component loading may be performed, thereby improving the resource utilization and improving the smoothness of loading.

In the case where the components need to be loaded, step 610 is executed, where the components in the first loading batch are loaded by reading the obtained component loading configuration.

In step 611, after the components in the first loading batch are loaded, it may be determined whether the components in the next loading batch need to be loaded before the room entry interface callback.

In the case where the components need to be loaded, step 612 is executed to sequentially load the components in the next loading batch until the components that need to be loaded before the room entry interface callback are completely loaded. Then step 613 is executed to place the process in the waiting state, waiting for the room entry interface callback.

In the case where the components do not need to be loaded, step 613 may be directly executed, waiting for the room entry interface callback.

Through the above steps 607 to 613, the component loading before the room entry interface callback may be completed, and the loading efficiency may be improved, thereby improving the user experience. Next, how to load the components after the room entry interface callback in another process branch 614 to 624 is described.

In step 614, a call request for the room entry interface may be sent.

In step 615, it may be determined that the room entry interface request is completed, that is, the room entry interface callback is received.

In step 616, since the process of loading components before the room entry interface callback and the process of loading components after the room entry interface callback are performed asynchronously, when performing component loading, it is first determined, according to the relevant identification in the configuration information, whether the components need to be loaded before the room entry interface callback.

In the case where the components need to be loaded, step 617 is executed, to determine whether the components that need to be loaded before the room entry interface callback are completely loaded.

In the case where the components are not completely loaded, step 618 is executed to place the user device in a waiting state, waiting for the components that need to be loaded before the room entry interface callback to be completely loaded.

Step 612 will also monitor the waiting state of step 618, and when it is detected that the user device enters the waiting state of step 618, and the components that need to be loaded before the room entry interface callback in step 612 are completely loaded, step 619 may be executed to send a notification that the components that need to be loaded before the room entry interface callback are completely loaded.

Returning to step 617, in the case where the components are completely loaded, step 620 is executed, to start loading the components of the first loading batch after the room entry interface callback.

In step 621, after the components of the first loading batch after the room entry interface callback are loaded, the components of the next loading batch may be sequentially loaded until the live streaming component is completely loaded, and step 622 is executed to complete the loading of the live streaming component.

Returning to step 616, in the case where the components do not need to be loaded, step 623 is executed, to start loading the components of the first one loading batch.

In step 624, after the components in the first one loading batch are loaded, the components in the next loading batch are sequentially loaded, until the live streaming component is completely loaded, and the process enters step 622.

The component loading method in the live streaming scenario is described above with reference to FIG. 6. The component loading method allows the user device to parse different received function loading configuration information through the correspondence between functions and components to obtain corresponding component loading configuration information, and perform component loading according to the component loading configuration information.

For example, in response to testing being required or a change in the application scenario of the user device being detected, the cloud end may generate different first configuration information, and the user device, when receiving the different first configuration information, may obtain the corresponding second configuration information by parsing, so as to adjust the loading sequence of the components, without modifying the code logic or updating the version of the code.

The above is the component loading method provided by the embodiments of the present disclosure, which may improve the flexibility of component loading.

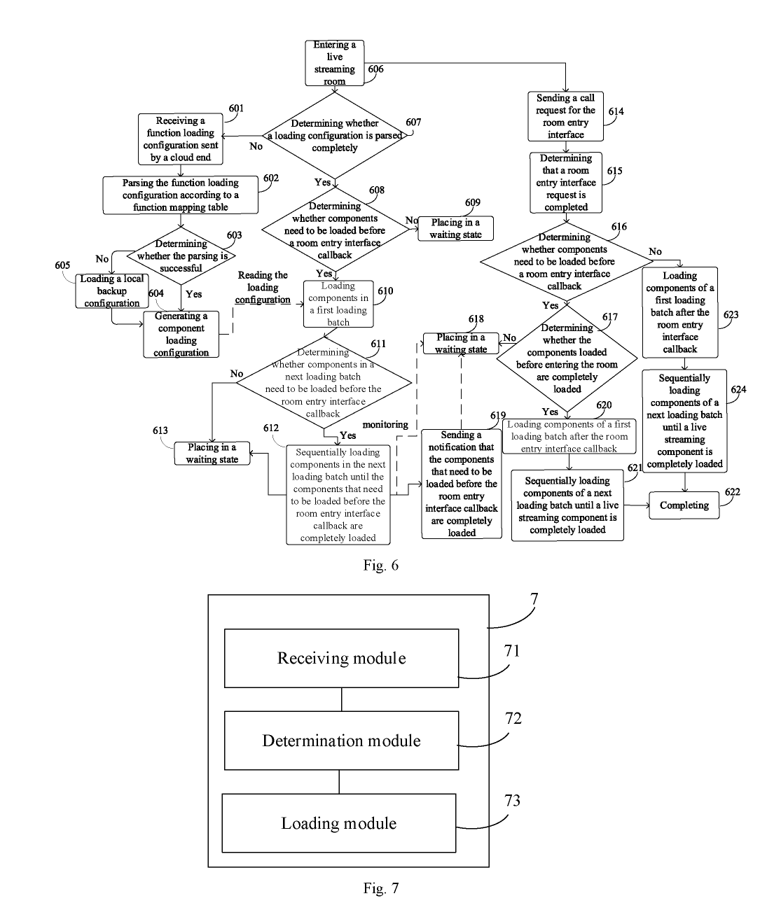

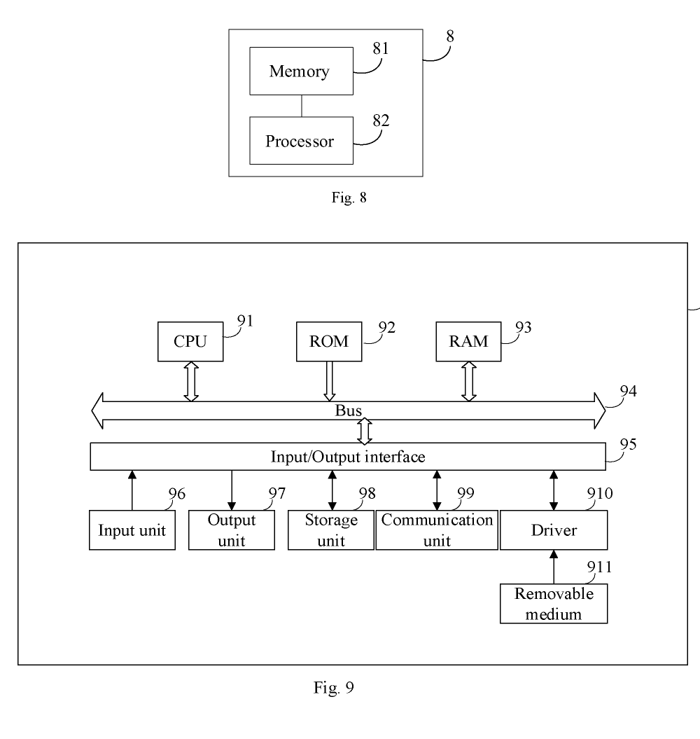

A user device according to embodiments of the present disclosure is described below with reference to FIGS. 7 and 8, which is configured to perform any one of the component loading methods described above. FIG. 7 shows a block diagram of a user device according to some embodiments of the present disclosure.

As shown in FIG. 7, the user device 7 comprises: a receiving module 71 configured to receive first configuration information, the first configuration information comprising a loading sequence of a functions to be loaded; a determination module 72 configured to determine second configuration information according to a correspondence between functions and components and the first configuration information, wherein the second configuration information comprising a loading sequence of components corresponding to the function; and a loading module 73 configured to load the components according to the second configuration information.

The receiving module 71 of the user device 7 may be configured to perform step S1 in FIG. 1, for example. The determination module 72 of the user device 7 may be configured to perform step S3 in FIG. 1, for example. The loading module 73 of the user device 7 may be configured to perform step S5 in FIG. 1, for example.

The user device of the present disclosure, may allow the user device to parse the received function loading configuration information through the correspondence between functions and components to obtain specific component loading configuration information, and perform loading according to the component loading configuration information, thereby improving the flexibility of component loading.

FIG. 8 shows a block diagram of a user device according to some other embodiments of the present disclosure.

As shown in FIG. 8, the user device 8 comprises: at least one memory 81; and at least one processor 82 coupled to the at least one memory 81, the at least one processor 82 configured to, based on instructions stored in the at least one memory 81, execute the component loading method according to any one of the embodiments described above.

The memory 81 is used to store one or more computer-readable instructions. The memory 81 may comprise any combination of various forms of computer-readable storage media, such as volatile memory and/or non-volatile memory, comprising but not limited to random access memory (RAM), dynamic random access memory (DRAM), static random access memory (SRAM), read-only memory (ROM), and flash memory. The memory 111 may store, for example, an operating system, an application, a boot loader, a database, other programs, etc., and may also store various applications, various data, etc.

The processor 82 is used to run the computer-readable instructions to implement the component loading method according to any one of the embodiments described above. For the specific implementation of each step of the method, reference may be made to the above embodiments, such as the steps in FIGS. 1-6, and the repeated parts are not described herein.

The user device of the present disclosure may allow the user device to parse the received function loading configuration information through the correspondence between functions and components to obtain specific component loading configuration information, and perform loading according to the component loading configuration information, thereby improving the flexibility of component loading.

The processor 82 may be embodied as various processing apparatuses, such as a central processing unit (CPU), a network processor (NP), etc.; and may also be a digital signal processor (DSP), an application specific integrated circuit (ASIC), a field programmable gate array (FPGA) or other programmable logic devices, a discrete gate or transistor logic device, or a discrete hardware component. The central processing unit (CPU) may have an X86 or ARM architecture or the like.

The processor 82 and the memory 81 may directly or indirectly communicate with each other. For example, the processor 82 and the memory 81 may communicate through a network. The network may comprise a wireless network, a wired network, and/or any combination of a wireless network and a wired network. The processor 82 and the memory 81 may also communicate with each other through a system bus, which is not limited in the present disclosure.

It should be noted that the components of the user device 8 shown in FIG. 8 are only exemplary and non-restrictive, and the user device 8 may further have other components according to actual application needs. The processor 82 may control other components in the user device 8 to perform desired functions.

The user device 8 may be implemented by software, firmware, and/or hardware, and may be integrated in an apparatus installed with relevant applications.

FIG. 9 shows a block diagram of an electronic device according to some embodiments of the present disclosure.

The electronic device 9 shown in FIG. 9 may be a computer system having a dedicated hardware structure, and may perform corresponding functions when installed with relevant applications.

The electronic device comprises, but is not limited to, mobile terminals such as smart phones, notebooks, personal digital assistants (Personal Digital Assistant, PDA), tablet computers (Tablet Personal Computer, Tablet PC), PMPs (portable multimedia players), vehicle terminals (e.g., vehicle navigation terminals), wearable devices, etc., and stationary terminals such as digital TVs, desktop computers, etc.

As shown in FIG. 9, a central processing unit (CPU) 91 executes various processes according to a program stored in a read-only memory (ROM) 92 or a program loaded from a storage unit 98 into a random access memory (RAM) 93. The RAM 93 stores therein data required when the CPU 91 executes the various processes as necessary. The central processing unit is only exemplary, and it may be other types of processors, such as the various processors described above. The ROM 92, the RAM 93, and the storage unit 98 may be various forms of computer-readable storage media. It should be noted that although the ROM 92, the RAM 93, and the storage unit 98 are shown separately in FIG. 9, one or more of them may be combined or located in the same or different memories or storage modules.

The CPU 91, the ROM 92, and the RAM 93 are connected to each other via a bus 94. An input/output interface 95 is also connected to the bus 94.

The following components are connected to the input/output interface 95: an input unit 96 such as a touch screen, a touchpad, a keyboard, a mouse, an image sensor, a microphone, an accelerometer, and a gyroscope; an output unit 97 comprising a display such as a cathode ray tube (CRT), a liquid crystal display (LCD), a speaker, a vibrator, etc.; the storage unit 98 comprising a hard disk, a magnetic tape, etc.; and a communication unit 99 comprising a network interface card such as a LAN card, a modem, etc. The communication unit 99 allows communication processing to be performed via a network such as Internet. It is easy to understand that although some components in the electronic device 9 are shown in FIG. 9 to communicate through the bus 94, they may also communicate through a network or other means, where the network may comprise a wireless network, a wired network, and/or any combination of a wireless network and a wired network.

As needed, a driver 910 is also connected to the input/output interface 95. A removable medium 911 such as a magnetic disk, an optical disc, a magneto-optical disc, a semiconductor memory, or the like is mounted on the driver 910 as needed, so that a computer program read therefrom is installed into the storage unit 98 as needed.

In response to the above-described series of processes being implemented by software, a program constituting the software may be installed from a network such as Internet or a storage medium such as the removable medium 911.

According to an embodiment of the present disclosure, the process described above with reference to the flowchart may be implemented as a computer software program. For example, some embodiments of the present disclosure comprise a computer program product, which, when running on a computer, causes the computer to implement the component loading method according to any one of the embodiments described above. The computer program product comprises computer instructions carried on a computer-readable medium, comprising program code for performing the method shown in the flowchart. In such an embodiment, the computer instructions may be downloaded and installed from a network through the communication unit 99, or installed from the storage unit 98, or installed from the ROM 92. When the computer program is executed by the CPU 91, the method of the embodiments of the present disclosure is executed.

The component loading method, may allow the user device to parse the received function loading configuration information through the correspondence between functions and components to obtain specific component loading configuration information, and perform loading according to the component loading configuration information, thereby improving the flexibility of component loading.

It is to be noted that, in the context of the present disclosure, the computer-readable medium may be a tangible medium that may comprise or store a program to be used by or in combination with an instruction execution system, apparatus, or device.

The computer-readable medium may be a computer-readable storage medium, a computer-readable signal medium, or any combination thereof.

The computer-readable storage medium comprises, but is not limited to, an electrical, magnetic, optical, electromagnetic, infrared, or semi-conductive system, apparatus, device, or any combination thereof. More specific examples of the computer-readable storage medium may comprise, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that comprises or stores a program, and the program may be used by or in combination with an instruction execution system, apparatus, or device. The computer-readable storage medium has computer instructions stored thereon, and the instructions, when executed by a processor, implement the component loading method according to any one of the embodiments described above.

The component loading method may allow the user device to parse the received function loading configuration information through the correspondence between functions and components to obtain specific component loading configuration information, and perform loading according to the component loading configuration information, thereby improving the flexibility of component loading.

The computer-readable signal medium may comprise a data signal propagated on a baseband or as a part of a carrier wave, and computer-readable program code is carried therein. The data signal propagated in this manner may be in multiple forms, and comprises, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted by any suitable medium, comprising, but not limited to: a wire, an optical cable, a radio frequency (RF), etc., or any suitable combination thereof.

The computer-readable medium described above may be comprised in the electronic device described above; or it may exist alone without being assembled into the electronic device.

In some embodiments, there is further provided a computer program, comprising: instructions that, when executed by a processor, cause the processor to perform the method according to any one of the embodiments described above. For example, the instructions may be embodied as computer program code.

In the embodiments of the present disclosure, the computer program code for performing the operations of the present disclosure may be written in one or more programming languages or a combination thereof, where the programming languages comprise, but are not limited to, object-oriented programming languages such as Java, Smalltalk, and C++, and further comprise conventional procedural programming languages such as "C" language or similar programming languages. The program code may be executed entirely on a user computer, partly on a user computer, as a stand-alone software package, partly on a user computer and partly on a remote computer, or entirely on a remote computer or server. In the case of involving the remote computer, the remote computer may be connected to the user computer through any kind of network (comprising a local area network (LAN) or a wide area network (WAN)), or it may be connected to an external computer (for example, connected by using Internet provided by an Internet service provider).

The flowchart and block diagrams in the drawings illustrate the possibly implemented architectures, functions, and operations of the system, method, and computer program product according to various embodiments of the present disclosure. In this regard, each block in the flowchart or block diagrams may represent a module, program segment, or part of code, which comprises one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagrams and/or flowcharts, and a combination of the blocks in the block diagrams and/or flowcharts may be implemented by a dedicated hardware-based system that executes specified functions or operations, or may be implemented by a combination of dedicated hardware and computer instructions.

The functions described above may be performed at least in part by one or more hardware logic components. For example, without limitation, exemplary hardware logic components that may be used comprise: a field programmable gate array (FPGA), an application specific integrated circuit (ASIC), an application specific standard product (ASSP), a system on chip (SOC), a complex programmable logical device (CPLD) and more.

Although some specific embodiments of the present disclosure have been described in detail through examples, those skilled in the art should understand that the above examples are only for illustration, and are not intended to limit the scope of the present disclosure. Those skilled in the art should understand that the above embodiments may be modified without departing from the scope and spirit of the present disclosure. The scope of the present disclosure is defined by the appended claims.

What is claimed is:

1. A component loading method, comprising:
receiving first configuration information, the first configuration information comprising a loading sequence of functions to be loaded;
determining second configuration information according to a correspondence between functions and components and the first configuration information, wherein the second configuration information comprises a loading sequence of components corresponding to the functions; and
loading the components according to the second configuration information.

2. The component loading method of claim 1, wherein the loading sequence of the functions comprises loading batches of the functions, and determining the second configuration information according to the correspondence between functions and components and the first configuration information comprises:
determining, for each loading batch of the loading batches, components corresponding to a function in the loading batch according to the correspondence between functions and components;
determining a loading sequence of the components corresponding to the function in the loading batch according to a loading priority of the components; and
determining a loading sequence of all components corresponding to the functions to be loaded according to the loading batches of the functions and the loading sequence of the components corresponding to the function in every one of the loading batches.

3. The component loading method of claim 2, wherein the first configuration information further comprises a delay interval between the loading batches of the functions to be loaded, and the second configuration information further comprises a loading delay of the components corresponding to the functions to be loaded, determining the second configuration information according to the correspondence between functions and components and the first configuration information further comprises:
determining, for each loading batch of the loading batches, a loading delay of components corresponding to the function in the loading batch according to a delay interval between the loading batch and a next loading batch.

4. The component loading method of claim 3, wherein determining the loading delay of the components corresponding to the function in the loading batch according to the delay interval between the loading batch and the next loading batch comprises:
determining the loading delay according to the delay interval and a state of the user device, the state of the user device comprising at least one of a resource usage state or a network state.

5. The component loading method of claim 2, wherein loading the components according to the second configuration information comprises:
encapsulating, according to the second configuration information, loading of components corresponding to the function in each loading batch of the loading batches into a loading task, respectively;
generating a task queue according to loading tasks corresponding to every one of the loading batches; and
loading the components according to the task queue.

6. The component loading method of claim 2, wherein the first configuration information further comprises a first identification corresponding to each loading batch of the loading batches, the first identification indicating whether the loading batch supports loading before a specified interface is completed, and the component loading method further comprises:
dividing all the components into a first component set loaded before the specified interface is completed and a second component set loaded after the specified interface is completed according to the loading batches of the functions and the first identification corresponding to each loading batch.

7. The component loading method of claim 6, wherein loading the components according to the second configuration information comprises:
sending a call request for the specified interface;
loading the first component set according to the second configuration information;
determining whether the first component set is completely loaded in response to receiving a response to the call request;
loading the second component set according to the second configuration information in response to the first component set being completely loaded; and
waiting for the first component set to be completely loaded and then loading the second component set in response to the first component set not being completely loaded.

8. The component loading method of claim 2, wherein the first configuration information further comprises a second identification corresponding to each loading batch of the loading batches, the second identification indicating whether the functions in the loading batch are displayed concurrently.

9. The component loading method of claim 8, wherein determining the loading sequence of the components corresponding to the function in the loading batch according to the loading priority of the components comprises:
determining, for each loading batch of the loading batches, whether the loading sequence of the components corresponding to the function in the loading batch is loading in parallel according to the second identification corresponding to the loading batch; and
determining the loading sequence of the components corresponding to the function in the loading batch according to the loading priority of the components, in response to the loading sequence of the components corresponding to the function in the loading batch not being loading in parallel.

10. The component loading method of claim 1, wherein:
the first configuration information is dynamically changed and determined according to at least one of a application scenario or a testing requirement; and/or
the second configuration information is in one-to-one correspondence with the first configuration information.

11. A user device, comprising:
at least one memory; and
at least one processor coupled to the at least one memory, the at least one processor configured to, based on instructions stored in the at least one memory, execute a component loading method, comprising:
receiving first configuration information, the first configuration information comprising a loading sequence of functions to be loaded;
determining second configuration information according to a correspondence between functions and components and the first configuration information, wherein the second configuration information comprises a loading sequence of components corresponding to the functions; and
loading the components according to the second configuration information.

12. The user device of claim 11, wherein the loading sequence of the functions comprises loading batches of the functions, and determining the second configuration information according to the correspondence between functions and components and the first configuration information comprises:
determining, for each loading batch of the loading batches, components corresponding to a function in the loading batch according to the correspondence between functions and components;
determining a loading sequence of the components corresponding to the function in the loading batch according to a loading priority of the components; and
determining a loading sequence of all components corresponding to the functions to be loaded according to the loading batches of the functions and the loading sequence of the components corresponding to the function in every one of the loading batches.

13. The user device of claim 12, wherein the first configuration information further comprises a delay interval between the loading batches of the functions to be loaded, and the second configuration information further comprises a loading delay of the components corresponding to the functions to be loaded, determining the second configuration information according to the correspondence between functions and components and the first configuration information further comprises:
determining, for each loading batch of the loading batches, a loading delay of components corresponding to the function in the loading batch according to a delay interval between the loading batch and a next loading batch.

14. The user device of claim 13, wherein determining the loading delay of the components corresponding to the function in the loading batch according to the delay interval between the loading batch and the next loading batch comprises:
determining the loading delay according to the delay interval and a state of the user device, the state of the user device comprising at least one of a resource usage state or a network state.

15. The user device of claim 12, wherein loading the components according to the second configuration information comprises:
encapsulating, according to the second configuration information, loading of components corresponding to the function in each loading batch of the loading batches into a loading task, respectively;
generating a task queue according to loading tasks corresponding to every one of the loading batches; and
loading the components according to the task queue.

16. The user device of claim 12, wherein the first configuration information further comprises a first identification corresponding to each loading batch of the loading batches, the first identification indicating whether the loading batch supports loading before a specified interface is completed, and the component loading method further comprises:
dividing all the components into a first component set loaded before the specified interface is completed and a second component set loaded after the specified interface is completed according to the loading batches of the functions and the first identification corresponding to each loading batch.

17. The user device of claim 16, wherein loading the components according to the second configuration information comprises:
sending a call request for the specified interface;
loading the first component set according to the second configuration information;
determining whether the first component set is completely loaded in response to receiving a response to the call request;
loading the second component set according to the second configuration information in response to the first component set being completely loaded; and
waiting for the first component set to be completely loaded and then loading the second component set in response to the first component set not being completely loaded.

18. The user device of claim 12, wherein the first configuration information further comprises a second identification corresponding to each loading batch of the loading batches, the second identification indicating whether the functions in the loading batch are displayed concurrently.

19. The user device of claim 18, wherein determining the loading sequence of the components corresponding to the function in the loading batch according to the loading priority of the components comprises:
determining, for each loading batch of the loading batches, whether the loading sequence of the components corresponding to the function in the loading batch is loading in parallel according to the second identification corresponding to the loading batch; and
determining the loading sequence of the components corresponding to the function in the loading batch according to the loading priority of the components, in response to the loading sequence of the components corresponding to the function in the loading batch not being loading in parallel.

20. A non-transitory computer-readable storage medium having computer instructions stored thereon, wherein the instructions, when executed by a processor, implement a component loading method, comprising:
receiving first configuration information, the first configuration information comprising a loading sequence of functions to be loaded;
determining second configuration information according to a correspondence between functions and components and the first configuration information, wherein the second configuration information comprises a loading sequence of components corresponding to the functions; and
loading the components according to the second configuration information.
